(19) United States
(12) Patent Application Publication
(10) Pub. No.: US 2008/0131761 A1
(43) Pub. Date: Jun. 5, 2008

(54) MULTI-CELLS CONNECTION BOARD (MCB) ASSEMBLY AND ITS FABRICATION METHOD

(76) Inventors: Jenchih Liu, Taipei City (TW); Yofu Fang, Taipei City (TW); Chunchu Lin, Taipei City (TW)

Correspondence Address: SINORICA, LLC, 528 FALLSGROVE DRIVE, ROCKVILLE, MD, 20850, US

(21) Appl. No.: 11/744,402

(22) Filed: May 4, 2007

(30) Foreign Application Priority Data
Dec. 1, 2006 (TW) 095144655

(51) Int. Cl. H01M 2/10; H01M 4/82

(52) U.S. Cl. 429/99; 29/623.1

(57) ABSTRACT

A MCB assembly is disclosed to include an electrically insulative mounting board, which has an end plate and cell compartments extending from the end plate in a parallel manner and spaced from one another by a respective narrow crevice for dividing a plurality of battery cells, a metal conducting strip bar, which is joined to the electrically insulative mounting board by means of injection molding, having a plurality of metal conducting strips and two connecting strips respectively formed integral with the opposite ends of the metal conducting strips that are separated from the metal conducting strips after joining of the metal conducting strip bar to the mounting board, and a sensor connector mounted in through holes on the end plate of the mounting board and bonded with metal terminals thereof to a respective conducting bonding hole on each of the metal conducting strips.

### BACKGROUND OF THE INVENTION

1. Field of the Invention

The present invention relates to a battery mounting structure and more particularly, to a multi-cells connection board (MCB) assembly, which has a simple structure and is inexpensive to manufacture. The invention relates also to a battery fabrication method, which has the advantages of high yield rate and low manufacturing cost.

2. Description of the Related Art

Regular handheld or mobile apparatus, more particularly, mobile electronics, communication products, motor vehicles, and power hand tools commonly use a battery to provide the necessary working voltage. For the advantages of energy storage life, charging number of times, non-memory effect, and high energy density, Li-ion battery is the first choice in use. FIG. 1 shows a conventional Li-ion battery. As illustrated, the battery comprises a battery body 90 formed of a series of battery cells 91, and a circuit board 92 provided at the top side of the battery body 90. The circuit board 92 comprises an end board 921, and a plurality of cell compartments 922 extended from the end board 921 corresponding to the battery cells 91. The cell compartments 922 each have a metal conducting plate 93 at the top. The circuit board 92 holds, protects, and connects the battery cells 91, having printed thereon a metal conducting layer (not shown) corresponding to the metal conducting plate 93 and a circuit with a row of conducting holes 924 electrically extending from the metal conducting layer for the installation of an electric connector (not shown) for voltage detection.

During installation, the circuit board 92 is mounted on the top side of the battery body 90 to have the two metal conducting plates 911 at the top side of each of the battery cells 91 be inverted into the gap 923 between each two adjacent cell compartments 922, and then the two metal conducting plates 911 of each of the battery cells 91 are respectively bent toward two opposite sides and kept in positive contact with the respective metal conducting plates 93 of the circuit board 92. Thus, the circuit board 92 and the battery cells 90 are electrically connected together, forming the desired series or parallel battery configuration.

The aforesaid Li-ion battery structure achieves the expected function in use, however it still has drawbacks in structural design and fabrication. This design uses the circuit board 92 to hold the battery cells 91 in position, allowing the battery cells 91 to be electrically connected in series to form the battery body 90. However, this design of circuit board 92 is complicated and expensive to manufacture, and the fabrication of the circuit board 92 will cause environment pollutions. Therefore, this Li-ion battery structure is not an ideal design. Further, because the metal conducting plates 93 are independent members, they must be individually installed in the cell compartments 922 of the circuit board 92, thereby complicating the fabrication of the Li-ion battery. Improper installation may cause a short-circuit fault of the battery cells 91. Therefore, the fabrication of this design of Li-ion battery is not economic, lowering the market competitiveness of the product.

Therefore, it is desirable to provide a simple and economic battery fabrication method that eliminates the aforesaid drawbacks.

### SUMMARY OF THE INVENTION

The present invention has been accomplished under the circumstances in view. It is one object of the present invention to provide a battery mounting structure and its fabrication method, which simplifies the fabrication of battery, improves the manufacturing efficiency and economic effect of the product, and lowers the cost of the product. It is another object of the present invention to provide a battery mounting structure and its fabrication method, which simplifies the assembly process of the battery and eliminates the drawbacks of the use of a circuit board in the prior art design.

To achieve these and other objects and according to one embodiment of the present invention, the MCB assembly comprises an electrically insulative connection board, and a metal conducting strip bar. The electrically insulative mounting board comprises an end plate, and a plurality of cell compartments extending from one side of the end plate in a parallel manner and spaced from one another by a respective narrow crevice for dividing a plurality of battery cells. The metal conducting strip bar is joined to the electrically insulative mounting board by means of injection molding, comprising a plurality of metal conducting strips corresponding to the narrow crevices between each two adjacent cell compartments of the electrically insulative mounting board.

According to an alternate form of the present invention, the MCB assembly comprises an electrically insulative mounting board, and a metal conducting strip bar. The electrically insulative mounting board comprises an end plate, a plurality of cell compartments extending from one side of the end plate in a parallel manner and spaced from one another by a respective narrow crevice for dividing a plurality of battery cells, and two protruding blocks respectively extending from the end plate at two opposite lateral sides of the cell compartments. The metal conducting strip bar is joined to the electrically insulative mounting board by means of injection molding, comprising a plurality of metal conducting strips corresponding to the narrow crevices between each two adjacent cell compartments of the electrically insulative mounting board.

According to another alternate form of the present invention, the MCB assembly is mounted on top and bottom ends of a set of battery cells to electrically connect the battery cells together. The MCB assembly comprises two mounting boards, and two metal contact sets. The mounting boards are respectively attached to the top and bottom ends of the set of battery cells, each having a plurality of insertion holes corresponding to one of the positive and negative terminals of each of the battery cells. The two metal contact sets are respectively joined to the mounting boards by means of injection molding, and respectively electrically connected to the positive and negative terminals of the battery cells. Each metal contact set comprises at least one dual-contact metal contact plate and a single-contact metal contact plate.

Further, the MCB assembly fabrication method includes the steps of: (a) stamping a metal sheet member into a metal conducting strip bar, the metal conducting strip bar comprising a plurality of metal conducting strips and at least one breakable connecting member joining the metal conducting strips, the metal conducting strips each having a bonding hole at one end thereof; and (b) molding an electrically insulative mounting board on the metal conducting strip bar, the electrically insulative mounting board having an end plate and a plurality of cell compartments extending from one side of the end plate in a parallel manner and spaced from one another by a respective narrow crevice that is respectively disposed corresponding to the metal conducting strips.

### BRIEF DESCRIPTION OF THE DRAWINGS

FIG. 1 is a schematic drawing showing the structure of a Li-ion battery according to the prior art.

FIG. 2 is an exploded view of a Li-polymer battery in accordance with a first embodiment of the present invention.

FIG. 3 is an oblique bottom elevation of the mounting board assembly for the Li-ion battery according to the first embodiment of the present invention.

FIG. 4 is a schematic assembly view of the Li-ion battery according to the first embodiment of the present invention.

FIG. 5 corresponds to FIG. 4 when viewed from another angle.

FIG. 6 is a block diagram showing the manufacturing flow of the Li-ion battery according to the first embodiment of the present invention.

FIG. 7 is an exploded view of a Li-polymer battery in accordance with a second embodiment of the present invention.

FIG. 7A is an enlarged view of the upper part of FIG. 7, showing the structure of the mounting board assembly.

FIG. 8A is an oblique top elevation of the mounting board assembly shown in FIG. 7A.

FIG. 8B is an oblique bottom elevation of the mounting board assembly shown in FIG. 7A.

FIG. 9 is an oblique elevation of the Li-polymer battery according to the second embodiment of the present invention.

FIG. 10 is an exploded view of a Li-polymer battery in accordance with a third embodiment of the present invention.

FIG. 10A corresponds to FIG. 10 when viewed from another angle.

FIG. 11A is an elevational view of one mounting board of the mounting board assembly for the L-ion polymer battery according to the third embodiment of the present invention.

FIG. 11B corresponds to FIG. 11A when viewed from the other side.

FIG. 12 is an oblique elevation of the Li-polymer battery according to the third embodiment of the present invention.

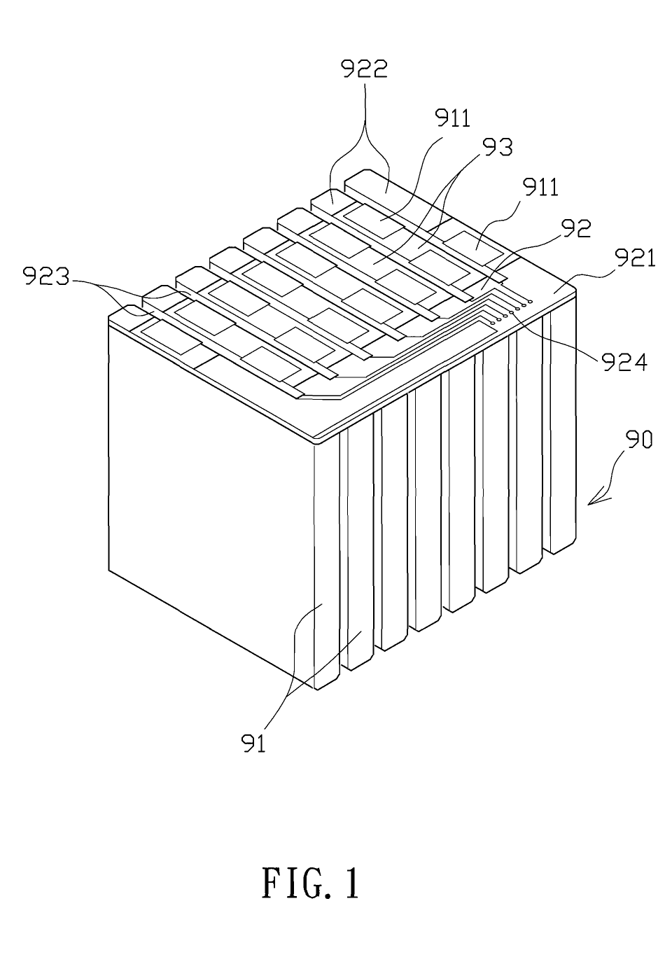

### DETAILED DESCRIPTION OF THE PREFERRED EMBODIMENT

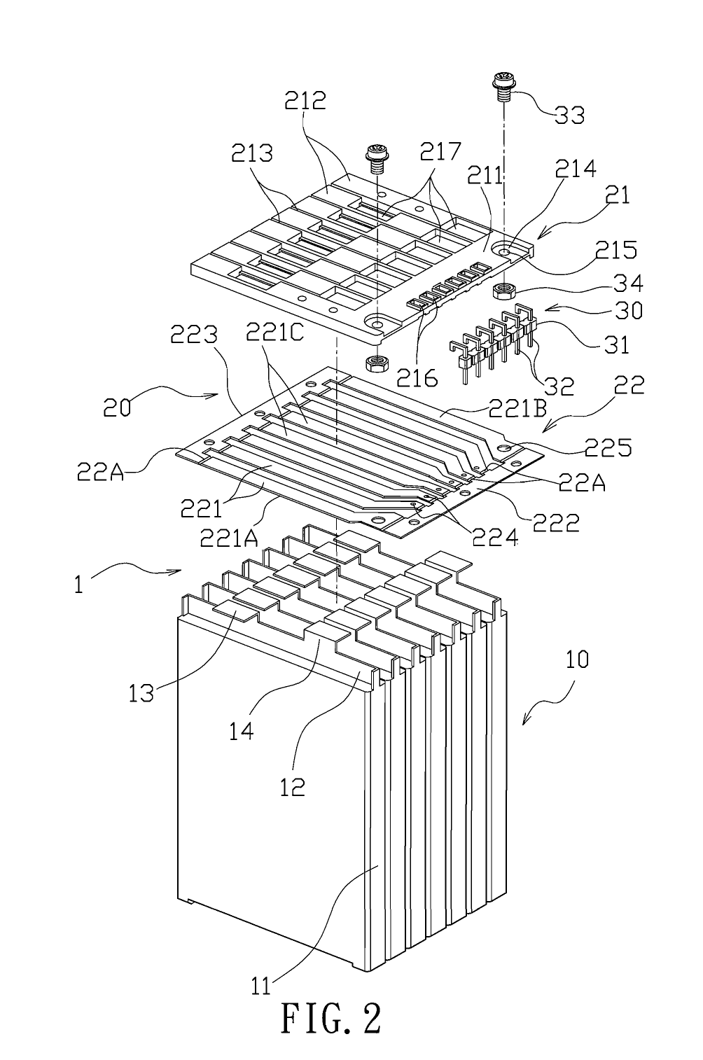

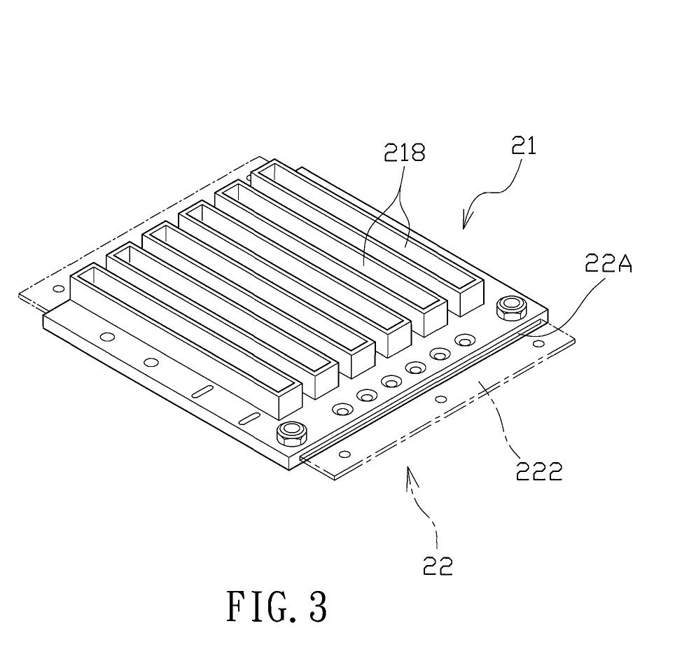

Referring to FIG. 2, a Li-polymer battery 1 in accordance with a first embodiment of the present invention is shown comprised of a battery body 10 and a mounting board assembly 20. The battery body 10 is comprised of a plurality of battery cells 11. Each battery cell 11 has a top channel 12, and two metal conducting plates, namely, the positive metal conducting plate 13 and the negative metal conducting plate 14. The top channel 12 protrudes vertically upwardly from the top side of the respective battery cell 11, having a substantially n-shaped cross section. The mounting board assembly 20 is comprised of a mounting board 21 and a metal conducting strip bar 22. The mounting board 21 has an end plate 211, and a plurality of cell compartments 212 extended from the end plate 211 in a parallel manner and spaced from one another by a respective narrow crevice 213. The end plate 211 has two recesses 214 near the two opposite lateral sides, a mounting hole 215 in each of the recesses 214, and a plurality of locating holes 216 spaced between the two recesses 214. Each cell compartment 212 has one or two receiving slots 217 facing the adjacent narrow crevice 213. The mounting board 21 further has a plurality of mounting grooves 218 on the bottom side corresponding to the intermediate cell compartments 212 between the first and last cell compartments (see FIG. 3). The metal conducting strip bar 22 comprises two connecting strips 222 and 223 arranged at two sides, and a plurality of metal conducting strips 221 connected between the metal connecting strips 222 and 223. Further, a tearing line 22A is respectively formed on the junction between each end of each of the metal conducting strips 221 and each of the metal connecting strips 222 and 223.

The metal conducting strips 221 include a left-side metal conducting strip 221A, a right-side metal conducting strip 221B, and a plurality of intermediate metal conducting strips 221C spaced between the left-side metal conducting strip 221A and the right-side metal conducting strip 221B. The intermediate metal conducting strips 221C each have a bonding hole 224 at one end, namely, the front end adjacent to the metal connecting strip 222. The front ends of the intermediate metal conducting strips 221C, except the center one, are respectively curved toward the center so that the space between each two bonding holes 224 is minimized. Further, the metal conducting strip bar 22 has two through holes 225 corresponding to the mounting holes 215 in the recesses 214 of the end plate 211.

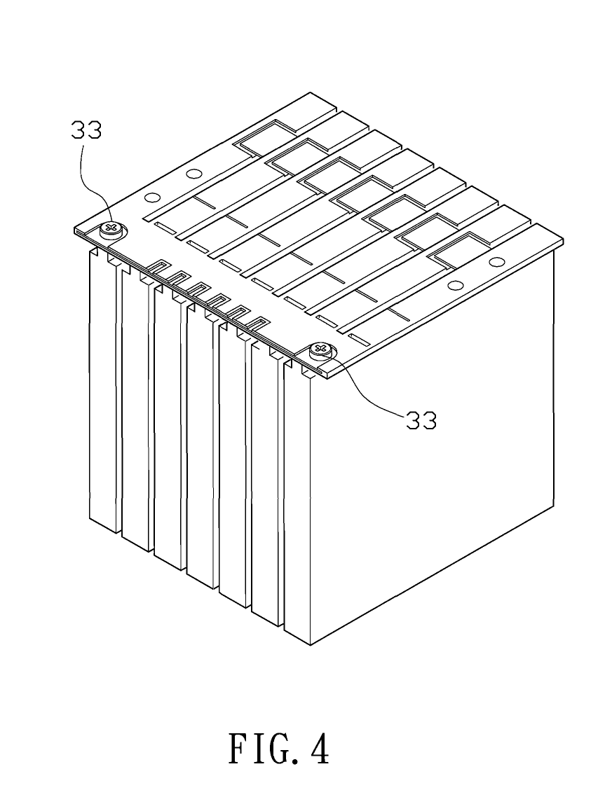

Referring to FIGS. 3 and 4, the mounting board 21 is made out of an electrically insulative material (plastics, rubber, or bakelite). Further, the mounting board 21 and the metal conducting strip bar 22 are formed in integrity to constitute the desired metal board assembly 20 through an injection molding process. The metal board assembly 20 is adapted to substitute for the circuit board used in the prior art design. After molding of the mounting board 21 on the metal conducting strip bar 22, the metal conducting strips 221 are exposed to the receiving slots 217 in the cell compartments 212 of the mounting board 21 for connection. Thereafter, the connecting strips 222 and 223 are separated from the metal conducting strips 221 through the tearing lines 22A. Further, a sensor connector 30 is installed in the mounting board assembly 20. The sensor connector 30 comprises a connector body 31 and a plurality of meal terminals 32 corresponding to the intermediate metal conducting strips 221C (see FIG. 2). The metal terminals 32 are mounted in the locating holes 216 of the mounting board 21, each having one end inserted through the end plate 211 and respectively soldered to the bonding holes 224 and the other end extending downwards for connection to a sensor holder that holds a voltage sensor (not shown).

As an alternate form of the present invention, the metal conducting strip bar 22 can be made having a plurality of metal conducting strips 221 and a plurality of thin connecting strips (not shown) respectively connected between each two adjacent metal conducting strips 221, i.e. the thin connecting strips are used to substitute for the aforesaid metal connecting strips 222 and 223. This measure eliminates the procedure of separating the aforesaid metal connecting strips 222 and 223 after injection molding of the mounting board 21 on the metal conducting strip bar 22. Further, the thin connecting strips are separated from the metal connecting strips 222 and 223 when the metal conducting strip bar 22 is put in the mold for injection molding. Further, the aforesaid bonding holes 224 may be eliminated from the intermediate metal conducting strips 221C. In this case, the metal terminals 32 of the sensor connector 30 are directly soldered to the intermediate metal conducting strips 221C.

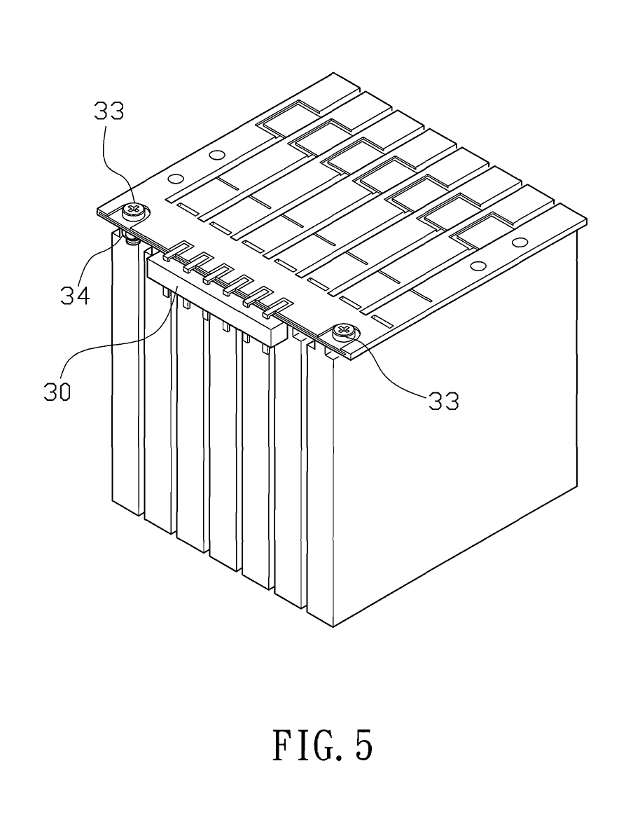

During installation of the Li-polymer battery 1, the mounting board assembly 20 is placed on the top side of the battery body 10 to have the channels 12 of the battery cells 11 be respectively engaged into the mounting grooves 218 on the bottom side of the mounting board 21, so that the positive metal conducting plates 13 and negative metal conducting plates 14 of the battery cells 11 are respectively inserted through the narrow crevices 213 of the mounting board 21. Thereafter, the positive metal conducting plates 13 and negative metal conducting plates 14 of the battery cells 11 are respectively bent toward the receiving slots 217 and electrically connected to the metal conducting strips 221 (a spot welding technique may be employed to assure positive connection between the positive metal conducting plates 13 and negative metal conducting plates 14 of the battery cells 11 and the metal conducting strips 221), thereby connecting the battery cells 11 in series (or in parallel). Thereafter, tie screws 33 are respectively inserted through the mounting holes 215 in the recesses 214 of the mounting board 21 and the through holes 225 of the metal conducting strip bar 22 and threaded into respective nuts 34 that are welded to or embedded in the battery body 10, thereby finishing the assembly process (see FIG. 5).

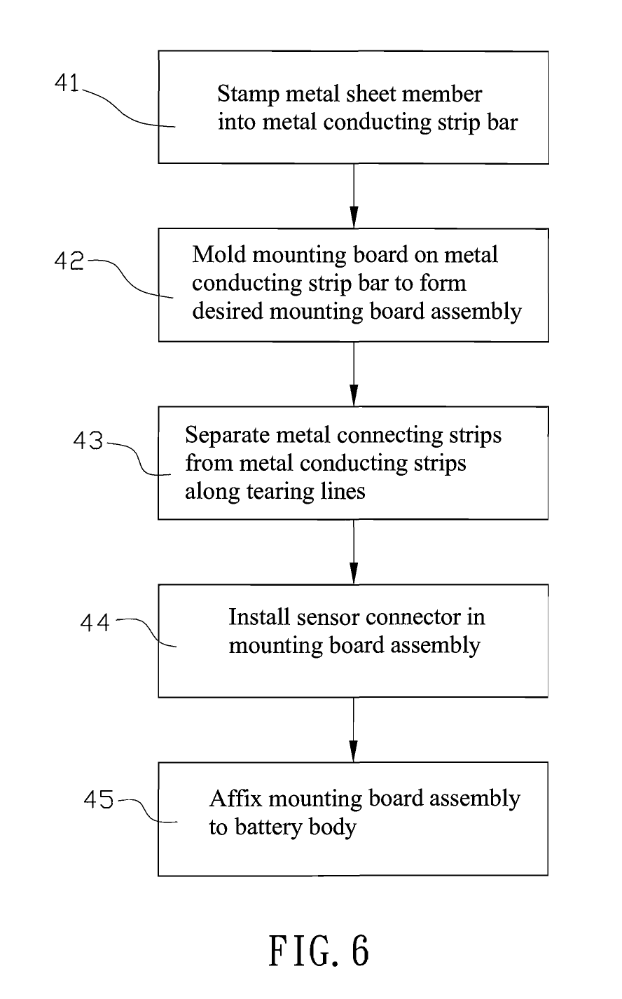

Referring to FIG. 6, the manufacturing process of the aforesaid Li-polymer battery 1 includes the steps of:

(41) Stamping a metal sheet member into a metal conducting strip bar, i.e. the aforesaid metal conducting strip bar 22, which comprises two connecting strips 222 and 223 and a plurality of metal conducting strips 221 connected in parallel between the metal connecting strips 222 and 223, wherein the metal conducting strips 221 include a left-side metal conducting strip 221A, a right-side metal conducting strip 221B, and a plurality of intermediate metal conducting strips 221C spaced between the left-side metal conducting strip 221A and the right-side metal conducting strip 221B; wherein the intermediate metal conducting strips 221C each have a bonding hole 224 at one end adjacent to the metal connecting strip 222; wherein the metal conducting strip bar 22 has a tearing line 22A on the junction between each end of each of the metal conducting strips 221 and each of the metal connecting strips 222 and 223, and two through holes 225 corresponding to the mounting holes 215 in the recesses 214 of the end plate 211;

(42) Preparing a mounting board, i.e., the aforesaid mounting board 21 having a plurality of cell compartments 212 arranged in parallel and separated from one another by a respective narrow crevice 213 and a plurality of bottom mounting grooves 218 on a bottom side of the cell compartments 212, and then injection molding the aforesaid mounting board 21 on the metal conducting strip bar 22 so that the mounting board 21 and the metal conducting strip bar 22 constitute a mounting board assembly 20;

(43) Separating the metal connecting strips 222 and 223 from the metal conducting strips 221 along the tearing lines 22A;

(44) Installing a sensor connector, i.e. the aforesaid sensor connector 30 having a connector body 31 and a plurality of metal terminals 32, by inserting the metal terminals 32 into the bonding holes 224 of the intermediate metal conducting strips 221C and soldering the metal terminals 32 to the intermediate metal conducting strips 221C respectively; and

(45) Preparing a battery body 10, which is comprised of a plurality of battery cells 11, each battery cell 11 having a top channel 12 and a positive metal conducting plate 13 and a negative metal conducting plate 14, and then installing the mounting board assembly 20 with the sensor connector 30 in the battery body 10 by: engaging the top channels 12 of the battery cells 11 into the bottom mounting grooves 218 of the mounting board 21 to have the positive metal conducting plates 13 and negative metal conducting plates 14 of the battery cells 11 be respectively inserted through the narrow crevice 213 between each two cell compartments 212 and then connecting the positive metal conducting plates 13 and negative metal conducting plates 14 of the battery cells 11 to the metal conducting strips 221 and then fixedly fastening the mounting board assembly 20 to the battery body 10.

As stated above, the metal conducting strip bar 22 can be made having a plurality of metal conducting strips 221 and a plurality of thin connecting strips respectively connected between each two adjacent metal conducting strips 221, and the thin connecting strips are separated from the metal connecting strips 222 and 223 when the metal conducting strip bar 22 is put in the mold for injection molding. Further, the aforesaid bonding holes 224 are eliminated from the intermediate metal conducting strips 221C when the metal terminals 32 of the sensor connector 30 are directly soldered to the intermediate metal conducting strips 221C.

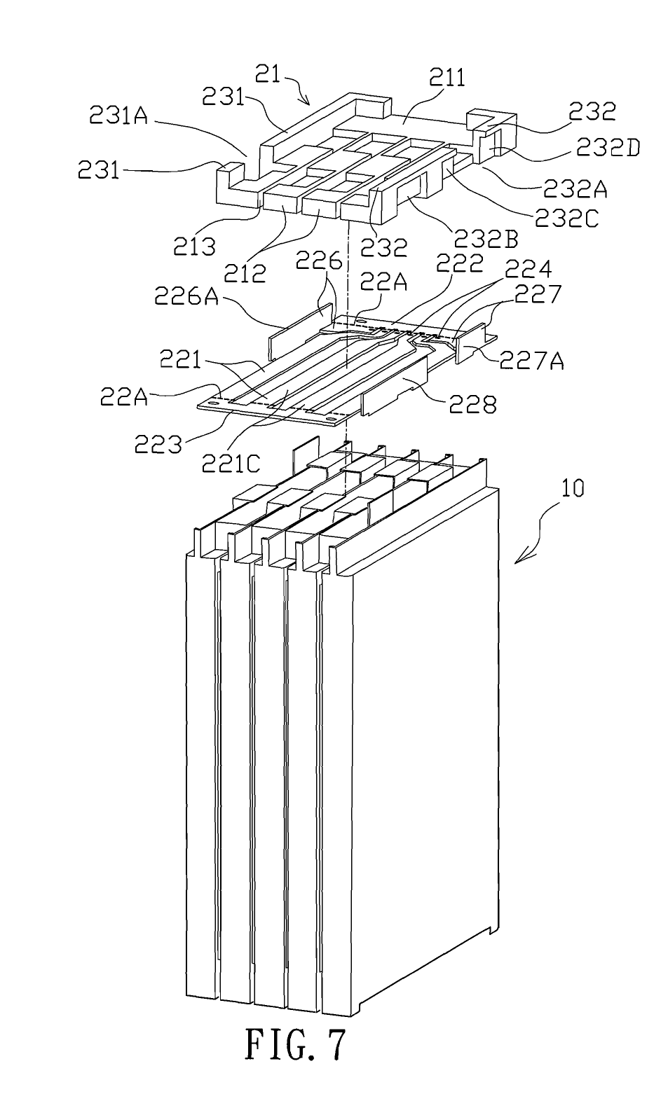

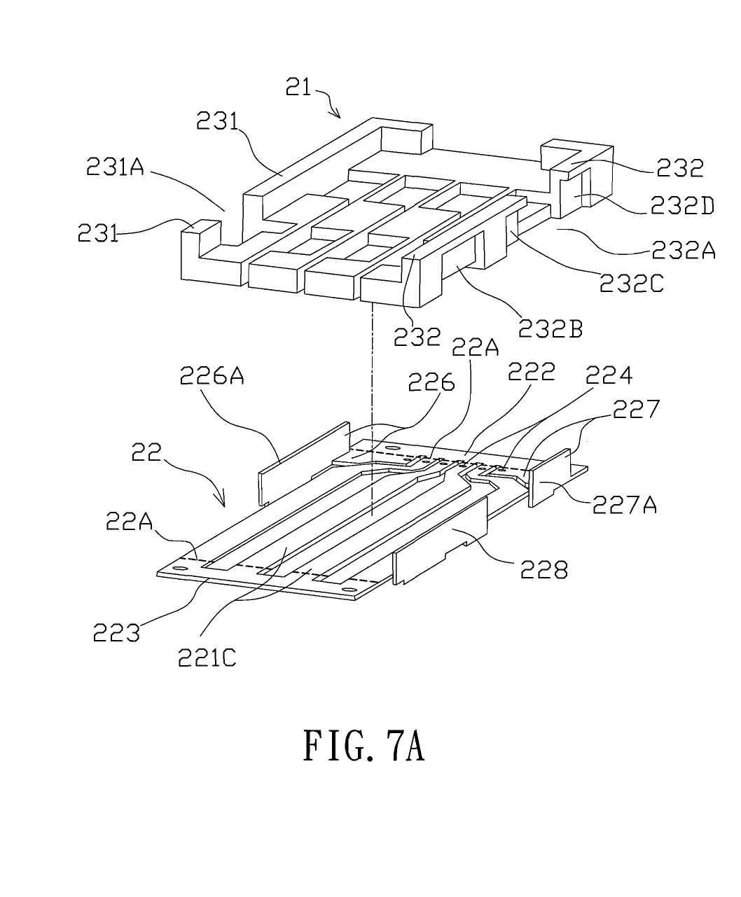

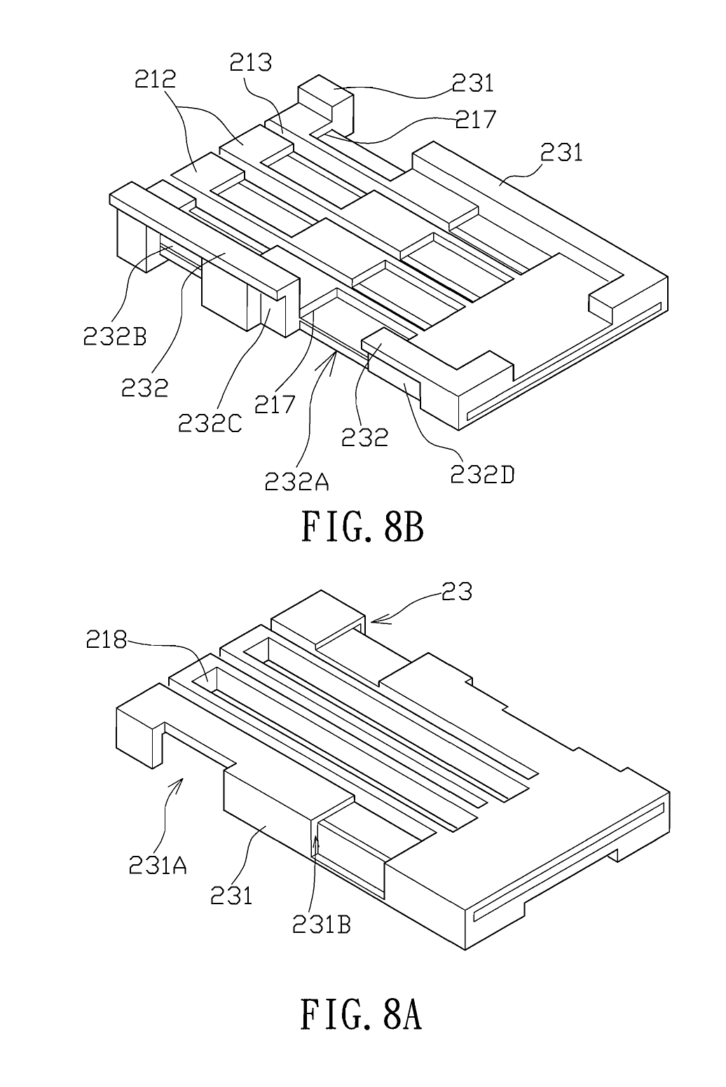

FIGS. 7˜9 show a Li-polymer battery in accordance with a second embodiment of the present invention. This embodiment is substantially similar to the aforesaid first embodiment with the exception of the structure of the mounting board assembly. It is to be understood that like reference sings (numerals) are used to indicate like parts through out the drawings of FIGS. 2˜12. According to this second embodiment, the mounting board 21 comprises an end plate 211, and a plurality of cell compartments 212 respectively extended from the end plate 211 in a parallel manner and separated from one another by respective narrow crevice 213. The end plate 211 has two protruding blocks 231 and 232 disposed at two opposite lateral sides relative to the cell compartments 212. Each cell compartment 212 has two receiving slots 217 facing the adjacent narrow crevice 213. The protruding blocks 231 and 232 have a height greater than the cell compartments 212. Further, the protruding blocks 231 and 232 each have a notch 231A or 232A corresponding to one receiving slot 217 of the respective adjacent cell compartment 212. One protruding block 231 further has a groove 231B on the outer wall. The other protruding block 232 further has three grooves 232B, 232C, and 232D on the outer wall. The metal conducting strip bar 22 comprises two connecting strips 222 and 223, a plurality of metal conducting strips 221 connected in parallel between and formed integral with the two connecting strips 222 and 223, and two protruding metal strips 226 and 227 disposed at two opposite lateral sides of the metal conducting strips 221. The two protruding metal strips 226 and 227 are joined to one connecting strip 222, each having a vertical strip portion 226A or 227A respectively extending from the outer side of the first or last one of the metal conducting strips 221 at right angles. The metal conducting strips 221 each have a bonding hole 224 at one end adjacent to the connecting strip 222 for the bonding of the sensor connector 30. Further, the right-sided metal conducting strips 221 has a vertical strip portion 228 spaced from and in line with the vertical strip portion 227A.

The mounting board 21 and the metal conducting strip bar 22 are joined together by means of injection molding. After molding, the metal conducting strips 221 are exposed to the receiving slots 217, the vertical strip portion 226A is engaged into the groove 231B on one protruding block 231, the vertical strip portion 227A is engaged into the groove 232D, and the vertical strip portion 228 is engaged into the grooves 232B and 232C. Thereafter, the connecting strips 222 and 223 are separated from the metal conducting strips 221 through the tearing lines 22A. Alternatively, the connecting strips 222 and 223 and the bonding holes 224 may be eliminated from the metal conducting strip bar 22 as the alternate form of the aforesaid first embodiment.

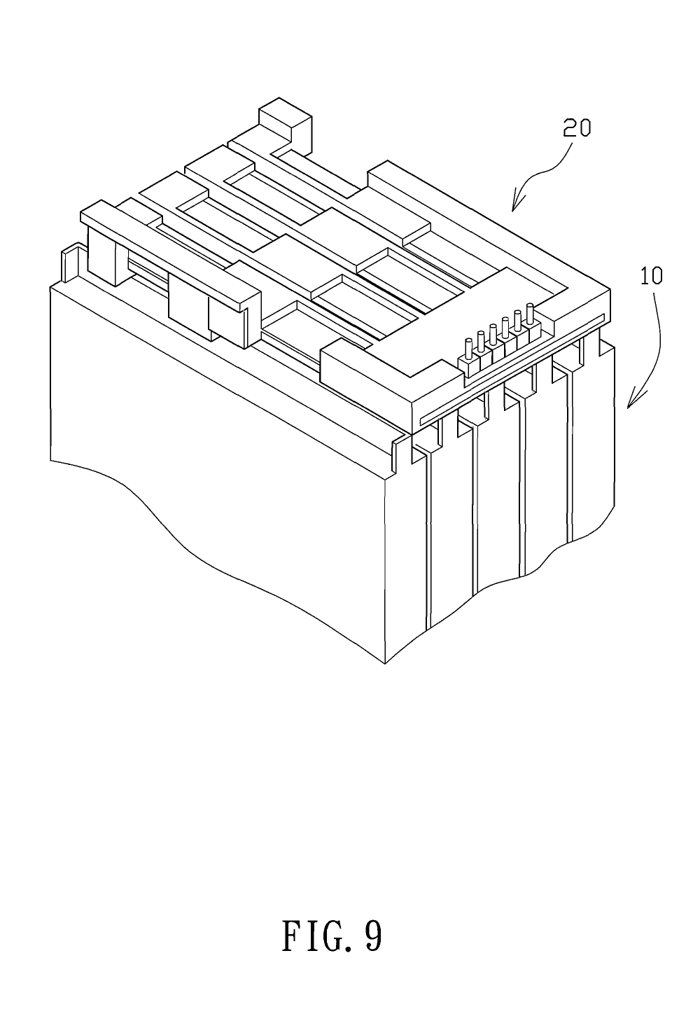

During installation of the Li-ion polymer battery 1, the channels 12 of the battery cells 11 are engaged into the mounting grooves 218 on the bottom side of the mounting board 21, so that the positive metal conducting plates 13 and negative metal conducting plates 14 of the battery cells 11 are respectively inserted through the narrow crevices 213 of the mounting board 21 and bent toward the receiving slots 217 and then electrically connected to the metal conducting strips 221, thereby connecting the battery cells 11 in series (or in parallel). Thereafter, tie screws 33 are installed to affix the mounting board assembly 22 and the body 10 together, as shown in FIG. 9.

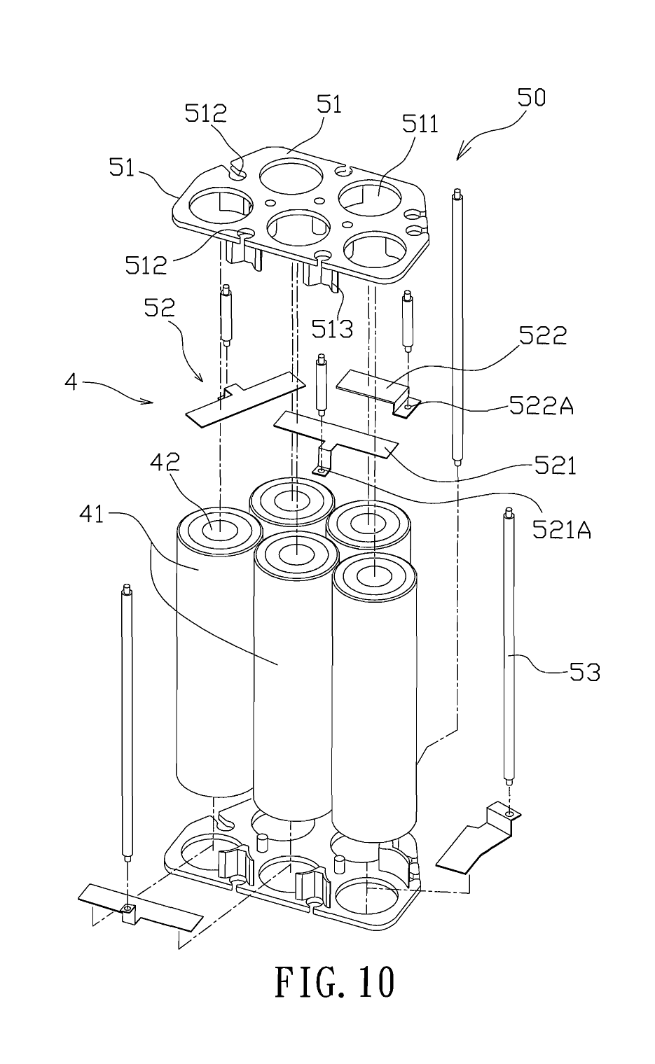

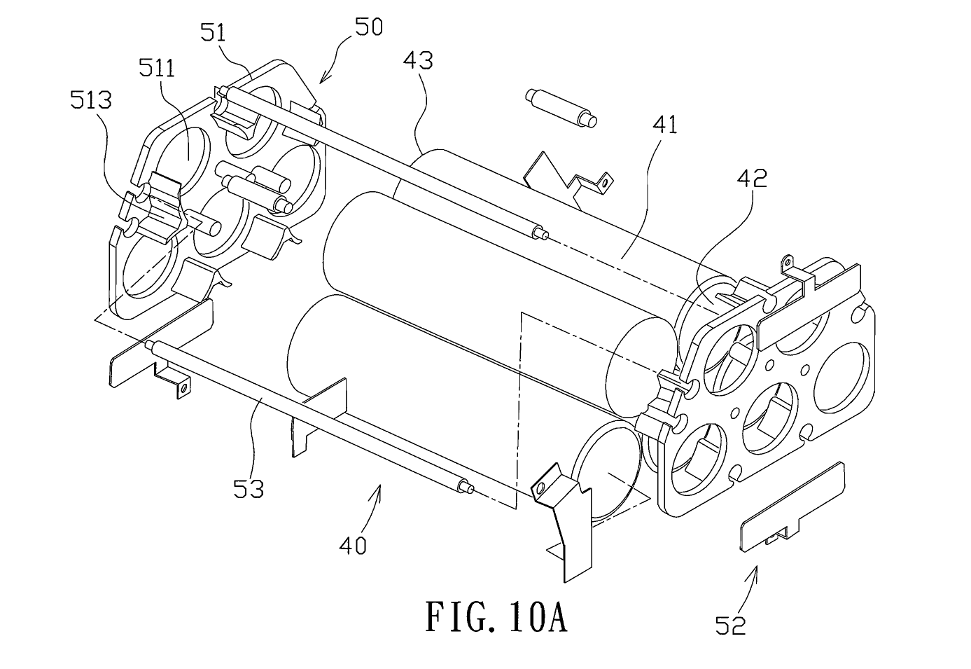

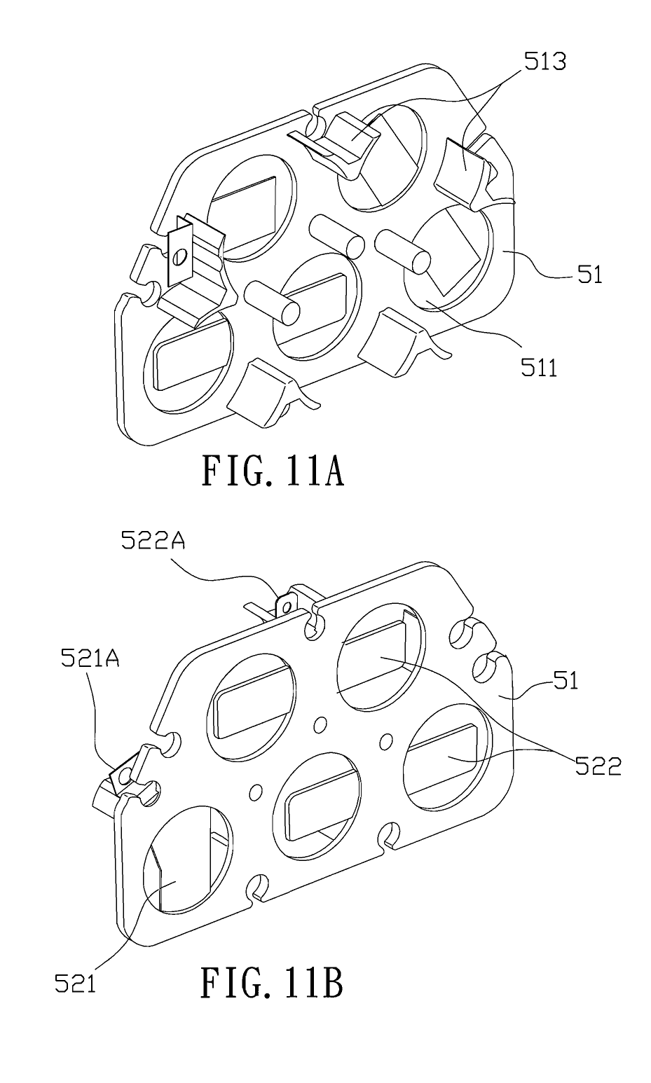

FIGS. 10˜12 show a Li-ion polymer battery 4 in accordance with a third embodiment of the present invention. According to this embodiment, the Li-ion polymer battery 4 comprises a battery body 40 and a mounting board assembly 50 fastened to the top and bottom ends of the battery body 40. The battery body 40 is comprised of a plurality of battery cells 41. Each battery cell 41 has a positive terminal 42 and a negative terminal 43. The mounting board assembly 50 comprises two mounting boards 51 respectively provided at the top and bottom sides of the battery cells 42, and two metal contact sets 52 respectively installed in the mounting boards 51. Each mounting board 51 has a plurality of insertion holes 511 corresponding to the positive terminals 42 or negative terminals 43 of the battery cells 41, a plurality of border mounting holes 512, and a plurality of positioning ribs 513 respectively extended from one side (the side facing the battery body 40) corresponding to the insertion holes 511. Each metal contact set 52 comprises a plurality of a plurality of dual-contact metal contact plates 521 and one single-contact metal contact plate 522. Each dual-contact metal contact plate 521 is electrically connected between two battery cells 41. Further, each dual-contact metal contact plate 521 has a mounting portion 521A extended from a middle part thereof at one side. The single-contact metal contact plate 522 has mounting portion 522A at one end, and is adapted to contact the positive terminal 42 or negative terminal 43 of one battery cell 41 that is not disposed in contact with the dual-contact metal contact plates 521. The mounting portions 521A and 522A are for the connection of electric wires 53.

The mounting board 51 and the associating metal contact sets 52 are joined together by means of injection molding. After molding of the mounting board 51 on the associating metal contact set 52, the dual-contact metal contact plates 521 and the single-contact metal contact plate 522 are respectively exposed to the insertion holes 511 for the contact of the positive terminals 42 or negative terminals 43 of the battery cells 41. Spot welding may be employed to fixedly connect the dual-contact metal contact plates 521 and single-contact metal contact plate 522 of the metal contact sets 52 to the positive terminals 42 and negative terminals 43 of the battery cells 41.

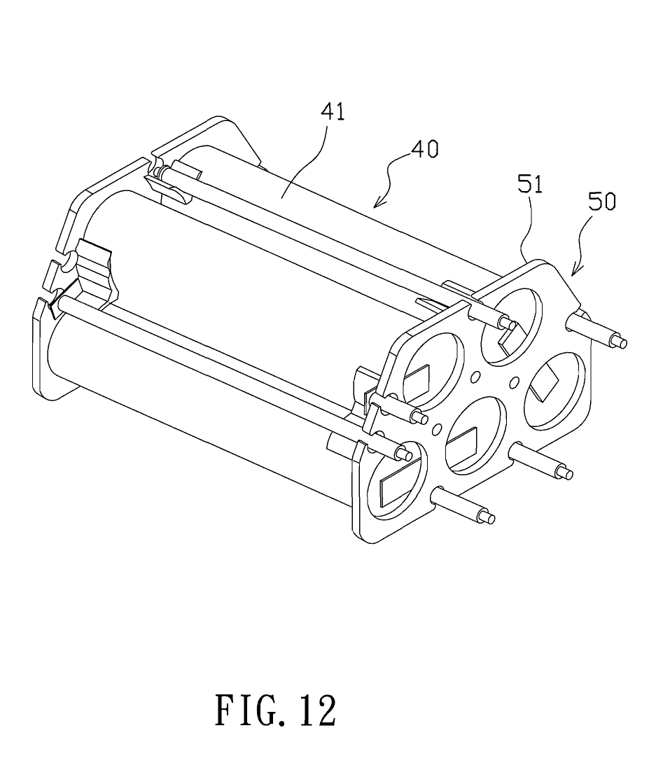

During assembly process of the Li-ion polymer battery 4, the mounting boards 51 of the mounting board assembly 50 are respectively attached to the top and bottom ends of the battery body 10 to have the battery cells 41 be held in place by the positioning ribs 513, and then the positive terminals 42 and negative terminals 43 of the battery cells 41 are respectively soldered to the metal contact sets 52, and electric wires 53 are respectively connected between the metal contact sets 52 of the mounting board assembly 50, and therefore the battery cells 41 are firmly held together and electrically connected in series (or in parallel), as shown in FIG. 12.

A prototype of battery mounting structure and its fabrication method has been constructed with the features of FIGS. 2˜12. The battery mounting structure and its fabrication method functions smoothly to provide all of the features discussed earlier.

Although particular embodiments of the invention have been described in detail for purposes of illustration, various modifications and enhancements may be made without departing from the spirit and scope of the invention.

What the invention claimed is:

1. A MCB assembly comprising:
an electrically insulative mounting board, said electrically insulative mounting board comprising an end plate, and a plurality of cell compartments extending from one side of said end plate in a parallel manner and spaced from one another by respective narrow crevices for dividing a plurality of battery cells; and
a metal conducting strip bar joined to said electrically insulative mounting board by means of injection molding, said metal conducting strip bar comprising a plurality of metal conducting strips corresponding to the narrow crevices between each two adjacent cell compartments of said electrically insulative mounting board.

2. The MCB assembly as claimed in claim 1, wherein said metal conducting strip bar further comprises at least one breakable connecting member that joins said metal conducting strips and is breakable from said metal conducting strips.

3. The MCB assembly as claimed in claim 2, wherein said metal conducting strip bar further comprises a row of conducting bonding holes on said metal conducting strips; said mounting board supports a sensor connector, having a plurality of locating holes corresponding to said conducting bonding holes and a plurality of bottom mounting grooves corresponding to said cell compartments for mounting of battery cells, said sensor connector comprising a plurality of metal terminals respectively inserted through said locating holes and respectively bonded to said conducting bonding holes.

4. A MCB assembly fabrication method comprising the steps of:
(a) stamping a metal sheet member into a metal conducting strip bar, said metal conducting strip bar comprising a plurality of metal conducting strips and at least one breakable connecting member joining said metal conducting strips, said metal conducting strips each having a bonding hole at one end thereof; and
(b) molding an electrically insulative mounting board on said metal conducting strip bar, said electrically insulative mounting board having an end plate and a plurality of cell compartments extending from one side of said end plate in a parallel manner and spaced from one another by respective narrow crevices, the narrow crevices between each two adjacent cell compartments being disposed corresponding to the metal conducting strips of said metal conducting strip bar.

5. The MCB assembly fabrication method as claimed in claim 4, further comprising, after step (b), the steps of:
(c) separating said at least one breakable connecting member from said metal conducting strips; and
(d) installing a sensor connector in said mounting board and soldering metal terminals of said sensor connector to the bonding holes of said metal conducting strips.

6. A MCB assembly comprising:
an electrically insulative mounting board, said electrically insulative mounting board comprising an end plate, a plurality of cell compartments extending from one side of said end plate in a parallel manner and spaced from one another by respective narrow crevices for dividing a plurality of battery cells, and two protruding blocks respectively extending from said end plate at two opposite lateral sides of said cell compartments; and
a metal conducting strip bar joined to said electrically insulative mounting board by means of injection molding, said metal conducting strip bar comprising a plurality of metal conducting strips corresponding to the narrow crevices between each two adjacent cell compartments of said electrically insulative mounting board.

7. The MCB assembly as claimed in claim 6, wherein said metal conducting strip bar further comprises two connecting strips respectively connected to two opposite ends of each of said metal conducting strips, a tearing line respectively connected between each of said connecting strips and each of said metal conducting strips through which said connecting strips are broken and separated from said metal conducting strips by an external force, said metal conducting strips each having a conducting bonding hole at one end thereof; wherein said electrically insulative mounting board supports a sensor connector, said sensor connector having a plurality of metal terminals respectively bonded to the conducting bonding holes of said metal conducting strips.

8. The MCB assembly as claimed in claim 7, wherein said protruding blocks of said electrically insulative mounting board each have a notch and at least one outer locating groove; said metal conducting strip bar further comprises two protruding metal strips disposed at two opposite lateral sides of said metal conducting strips, said two protruding metal strips being joined to one of said two connecting strips, said two protruding metal strips each having a vertical strip portion respectively extending from a respective adjacent one of said metal conducting strips at right angles, one of said metal conducting strips having a vertical strip portion spaced from and in line with the vertical strip portion of one of said two protruding metal strips.

9. A MCB assembly mounted on top and bottom ends of a set of battery cells to electrically connect said battery cells together, the MCB assembly comprising:
two mounting boards respectively attached to the top and bottom ends of said set of battery cells, said mounting board each having a plurality of insertion holes corresponding to one of the positive and negative terminals of each of said battery cells; and
two metal contact sets respectively joined to said mounting boards by means of injection molding and respectively electrically connected to the positive and negative terminals of said battery cells, said metal contact sets each comprising at least one dual-contact metal contact plate and a single-contact metal contact plate.

10. The MCB assembly as claimed in claim 1, wherein said mounting boards each have a plurality of border mounting holes, and a plurality of positioning ribs respectively extended from one side thereof corresponding to said insertion holes for holding said battery cells in place; wherein the dual-contact metal contact plates and single-contact metal contact plates of said metal contact sets each have a curved mounting portion.
